(19) United States
(12) Patent Application Publication
(10) Pub. No.: US 2025/0252011 A1
(43) Pub. Date: Aug. 7, 2025

(54) ADAPTIVE PROCESSING OBJECT ORIENTED SYSTEM AND METHOD

(71) Applicant: PaySend Group Limited, Scotland (GB)

(72) Inventors: Ivan ALEKSEEV, Belgrade (RS); Evgeny ALEKSEEV, Belgrade (RS); Dler SINO, Belgrade (RS)

(21) Appl. No.: 19/033,453

(22) Filed: Jan. 21, 2025

Related U.S. Application Data
(60) Provisional application No. 63/624,113, filed on Jan. 23, 2024.

(51) Int. Cl. G06F 11/07; G06F 9/50

(52) U.S. Cl. CPC G06F 11/0793; G06F 9/5083; G06F 11/0709; G06F 11/079

(57) ABSTRACT

The present invention involves coordinating distributed processing with a system and method which adaptively manages process implementation through a network appliance connected between computing devices connected through a network.

### CROSS-REFERENCE TO RELATED APPLICATIONS

The present application is a nonprovisional application which claims priority under 35 U.S.C. § 119(e) of U.S. Patent Provisional Application Ser. No. 63/624,113, filed Jan. 23, 2024, the disclosures of which are incorporated by reference herein.

### COPYRIGHT RESERVATION OF RIGHTS

This application includes some computer software listings, and as such a portion of the disclosure of this patent document contains material which is the subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

### Field of the Invention

The invention relates to network process management software. More specifically, but not exclusively, the field of the invention is that of distributed processing software for multiple network computing devices.

### Description of the Related Art

Distributed systems are systems whose components are located on different networked computers, which communicate and coordinate their actions by passing messages to one another. Distributed computing is a field of computer science that studies distributed systems. The components of a distributed system interact with one another in order to achieve a common goal. Three significant challenges of distributed systems are: maintaining concurrency of components, overcoming the lack of a global clock, and managing the independent failure of components. When a component of one system fails, the objective of distributed computing is to ensure that the entire system does not fail. Examples of distributed systems vary from SOA-based systems to massively multiplayer online games to peer-to-peer applications.

However, distributed systems may still be impaired, and full functionality denied, in the case of independent failure of components. It is desired to ensure against such failures while minimizing the impact on efficiency that is often involved in providing failure corrections.

### SUMMARY OF THE INVENTION

The present invention involves coordinating distributed processing with a system and method which allows for adaptively managing process implementation through a network appliance connected between computing devices connected through a network.

The present invention, in one form, relates to Open Processing Platform (OPP)—a universal processing solution to process anything, designed to be in the cloud. This solution also contains open API to communicate with external services and offer their functionality through standardized API for the platform's customers.

OPP was developed to achieve the highest level of autonomy and can scale and repair self by self. Each instance of OPP can be 100% available depends to release approach.

One of the important features of OPP is cloud independency. And second important is the ability to communicate with humans in any interaction environment. Interaction and Cloud independency, with autonomy and stability level, is key unique features of OPP.

OPP should have an ability to receive a complex requests with delegated logic. Normal processing requests contain only one requested operation. OPP allows us to send complex requests with execution routing logic. The core approach in all our systems is delegated logic. Consumers can use our systems to delegate complex logic in a single request. This approach simplifies the usage of our solutions by customers.

OPP contains a special function module that represents a unified API to interact with external systems in the integration of external services functionality into the OPP instance. This proxy module, on one hand, realizes internal intercommunication protocol and, on the second hand—universal API for external connections. Partners may realize external API and offer their functionality to OPP customers. OPP instance owner may manage these operations as wants and follow his agreements with partners.

100% SLA achieved through the release approach. Each deployment should creates a new Orchestrator tree. After testing the new Orchestrator tree, old trees are removed from the balancing mechanism and a new tree added. New trees and old trees may then work together.

The highest autonomy level is achieved by using the special approach called “Biological-Driven Development” (BDD). This method involves the following principals: Each damaged component should be destroyed without repair; Each orchestrator tree self-constructs the infrastructure by needs: Each functional block self-constructs the infrastructure based on RNA of the functional block; RNA coding involves the whole product functionality; and each functional block is equal to others in functional terms. With this approach, BDD helps remove humans from the exploitation process. With a universal level of abstraction of the interaction environment, BDD allows communication with humans in every interaction environment and may add any new interaction environment as a function of OPP.

The present invention, in another form, is a method for collecting, by the network appliance, telemetry data relating to a plurality of instances of network processes managed by the network appliance; determining through the network appliance, telemetry data comprising an instance network process failure; determining the RNA of the instance network process failure; and creating, by the network appliance, at least one new instance of a network process based on the determined RNA.

### BRIEF DESCRIPTION OF THE DRAWINGS

The above mentioned and other features and objects of this invention, either alone or in combinations of two or more, and the manner of attaining them, will become more apparent and the invention itself will be better understood by reference to the following description of an embodiment of the invention taken in conjunction with the accompanying drawings, wherein:

FIG. 1 is a schematic diagrammatic view of a network system in which embodiments of the present invention may be utilized.

FIG. 2 is a block diagram of a computing system (either a server or client, or both, as appropriate), with optional input devices (e.g., keyboard, mouse, touch screen, etc.) and output devices, hardware, network connections, one or more processors, and memory/storage for data and modules, etc. which may be utilized in conjunction with embodiments of the present invention.

FIG. 3 is a schematic chart diagram of the operation of the present invention relating to the load balancer of an embodiment of the present invention.

FIG. 4 is a schematic chart diagram of the operation of the present invention relating to the processing control of an embodiment of the present invention.

FIG. 5 is a schematic chart diagram of the operation of the present invention relating to the delegated logic schema of an embodiment of the present invention.

FIG. 6 is a schematic chart diagram of the operation of the present invention relating to the interaction schema of an embodiment of the present invention.

FIG. 7 is a schematic chart diagram of the operation of the present invention relating to the processing partner connection of an embodiment of the present invention.

FIG. 8 is a schematic chart diagram of the operation of the present invention relating to the interaction schema of an embodiment of the present invention.

Corresponding reference characters indicate corresponding parts throughout the several views. Although the drawings represent embodiments of the present invention, the drawings are not necessarily to scale and certain features may be exaggerated in order to better illustrate and explain the full scope of the present invention. The flow charts and screen shots are also representative in nature, and actual embodiments of the invention may include further features or steps not shown in the drawings. The exemplification set out herein illustrates an embodiment of the invention, in one form, and such exemplifications are not to be construed as limiting the scope of the invention in any manner.

### DESCRIPTION OF EMBODIMENTS OF THE PRESENT INVENTION

The embodiment disclosed below is not intended to be exhaustive or limit the invention to the precise form disclosed in the following detailed description. Rather, the embodiment is chosen and described so that others skilled in the art may utilize its teachings. While technology should continue to develop and many of the elements of the embodiments disclosed may be replaced by improved and enhanced items, the teaching of the present invention are inherent in the disclosure of the elements used in embodiments using technology available at the time of this disclosure.

The detailed descriptions which follow are presented in part in terms of algorithms and symbolic representations of operations on data bits within a computer memory representing alphanumeric characters or other information. A computer generally includes a processor for executing instructions and memory for storing instructions and data. When a general purpose computer has a series of machine encoded instructions stored in its memory, the computer operating on such encoded instructions may become a specific type of machine, namely a computer particularly configured to perform the operations embodied by the series of instructions. Some of the instructions may be adapted to produce signals that control operation of other machines and thus may operate through those control signals to transform materials far removed from the computer itself. Various forms of communication enable the remote and/or distributed processing of information as described in the various embodiments of this disclosure. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic pulses or signals capable of being stored, transferred, transformed, combined, compared, and otherwise manipulated. It proves convenient at times, principally for reasons of common usage, to refer to these signals as bits, values, symbols, characters, display data, terms, numbers, or the like as a reference to the physical items or manifestations in which such signals are embodied or expressed. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory, rather they represent specific electronic structural elements which impart or manifest a physical organization on the information stored in memory. More than mere abstraction, the data structures are specific electrical or magnetic structural elements in memory which simultaneously represent complex data accurately, often data modeling physical characteristics of related items, and provide increased efficiency in computer operation. By changing the organization and operation of data structures and the algorithms for manipulating data in such structures, the fundamental operation of the computing system may be changed and improved.

Further, the manipulations performed are often referred to in terms, such as comparing or adding, commonly associated with mental operations performed by a human operator. No such capability of a human operator is necessary, or desirable in most cases, in any of the operations described herein which form part of embodiments of the present invention; the operations are machine operations. The operations of these algorithms are deterministic with the accuracy and complexity management that are not obtainable by human mental steps even though the language used to describe them in the detailed description below at some time references a mental step. This requirement for machine implementation for the practical application of the algorithms is understood by those persons of skill in this art as not a duplication of human thought, rather as significantly more than such duplication. Useful machines for performing the operations of one or more embodiments of the present invention include general purpose digital computers or other similar devices. In all cases the distinction between the method operations in operating a computer and the method of computation itself should be recognized. One or more embodiments of present invention relate to methods and apparatus for operating a computer in processing electrical or other (e.g., mechanical, chemical) physical signals to generate other desired physical manifestations or signals. The computer operates on software modules, which are collections of signals stored on a media that represents a series of machine instructions that enable the computer processor to perform the machine instructions that implement the algorithmic steps. Such machine instructions may be the actual computer code the processor interprets to implement the instructions, or alternatively may be a higher level coding of the instructions that is interpreted to obtain the actual computer code. The computing machine may be a physical computing device, or a virtual computing device as is well known in the art. The software module may also include a hardware component, wherein some aspects of the algorithm are performed by the circuitry itself rather as a result of an instruction.

Some embodiments of the present invention also relate to an apparatus for performing these operations. This apparatus may be specifically constructed for the required purposes or it may comprise a general purpose computer as selectively activated or reconfigured by a computer program stored in the computer. The algorithms presented herein are not inherently related to any particular computer or other apparatus unless explicitly indicated as requiring particular hardware. In some cases, the computer programs may communicate or relate to other programs or equipment through signals configured to particular protocols which may or may not require specific hardware or programming to interact. In particular, various general-purpose machines may be used with programs written in accordance with the teachings herein, or it may prove more convenient to construct more specialized apparatus to perform the required method steps. The required structure for a variety of these machines will appear from the description below.

Embodiments of the present invention may deal with “object-oriented” software, and particularly with an “object-oriented” operating system. The “object-oriented” software is organized into “objects”, each comprising a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects.

Messages are sent and received between objects having certain functions and knowledge to carry out processes. Messages are generated in response to user instructions, for example, by a user activating an icon with a “mouse” pointer generating an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed to access. One feature of the object-oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by means of messages comprises an object-oriented program. Object-oriented computer programming facilitates the modeling of interactive systems in that each component of the system may be modeled with an object, the behavior of each component being simulated by the methods of its corresponding object, and the interactions between components being simulated by messages transmitted between objects.

An operator may stimulate a collection of interrelated objects comprising an object-oriented program by sending a message to one of the objects. The receipt of the message may cause the object to respond by carrying out predetermined functions which may include sending additional messages to one or more other objects. The other objects may in turn carry out additional functions in response to the messages they receive, including sending still more messages. In this manner, sequences of message and response may continue indefinitely or may come to an end when all messages have been responded to and no new messages are being sent. When modeling systems utilizing an object-oriented language, a programmer need only think in terms of how each component of a modeled system responds to a stimulus and not in terms of the sequence of operations to be performed in response to some stimulus. Such sequence of operations naturally flows out of the interactions between the objects in response to the stimulus and need not be preordained by the programmer.

Although object-oriented programming makes simulation of systems of interrelated components more intuitive, the operation of an object-oriented program is often difficult to understand because the sequence of operations carried out by an object-oriented program is usually not immediately apparent from a software listing as in the case for sequentially organized programs. Nor is it easy to determine how an object-oriented program works through observation of the readily apparent manifestations of its operation. Most of the operations carried out by a computer in response to a program are “invisible” to an observer since only a relatively few steps in a program typically produce an observable computer output.

In the following description, several terms which are used frequently have specialized meanings in the present context. The term “object” relates to a set of computer instructions and associated data which may be activated directly or indirectly by the user. The terms “windowing environment”, “running in windows”, and “object oriented operating system” are used to denote a computer user interface in which information is manipulated and displayed on a video display such as within bounded regions on a raster scanned, liquid crystal matrix, or plasma based video display (or any similar type video display that may be developed). The terms “network”, “local area network”, “LAN”, “wide area network”, or “WAN” mean two or more computers which are connected in such a manner that messages may be transmitted between the computers. In such computer networks, typically one or more computers operate as a “server”, a computer with large storage devices such as hard disk drives and communication hardware to operate peripheral devices such as printers or modems. Other computers, termed “workstations”, provide a user interface so that users of computer networks may access the network resources, such as shared data files, common peripheral devices, and inter-workstation communication. Users activate computer programs or network resources to create “processes” which include both the general operation of the computer program along with specific operating characteristics determined by input variables and its environment. Similar to a process is an agent (sometimes called an intelligent agent), which is a process that gathers information or performs some other service without user intervention and on some regular schedule. Typically, an agent, using parameters typically provided by the user, searches locations either on the host machine or at some other point on a network, gathers the information relevant to the purpose of the agent, and presents it to the user on a periodic basis. A “module” refers to a portion of a computer system and/or software program that carries out one or more specific functions and may be used alone or combined with other modules of the same system or program.

The term “desktop” means a specific user interface which presents a menu or display of objects with associated settings for the user associated with the desktop. When the desktop accesses a network resource, which typically requires an application program to execute on the remote server, the desktop calls an Application Program Interface, or “API”, to allow the user to provide commands to the network resource and observe any output. The term “Browser” refers to a program which is not necessarily apparent to the user, but which is responsible for transmitting messages between the desktop and the network server and for displaying and interacting with the network user. Browsers are designed to utilize a communications protocol for transmission of text and graphic information over a world wide network of computers, namely the “World Wide Web” or simply the “Web”. Examples of Browsers compatible with one or more embodiments of the present invention include the Chrome browser program developed by Google Inc. of Mountain View, California (Chrome is a trademark of Google Inc.), the Safari browser program developed by Apple Inc. of Cupertino, California (Safari is a registered trademark of Apple Inc.), Internet Explorer program developed by Microsoft Corporation (Internet Explorer is a trademark of Microsoft Corporation), the Opera browser program created by Opera Software ASA, or the Firefox browser program distributed by the Mozilla Foundation (Firefox is a registered trademark of the Mozilla Foundation). Although the following description may detail such operations in terms of a graphic user interface of a Browser, one or more embodiments of the present invention may be practiced with text based interfaces, or even with voice or visually activated interfaces, that have many of the functions of a graphic based Browser.

Browsers display information which is formatted in a Standard Generalized Markup Language (“SGML”) or a HyperText Markup Language (“HTML”), both being scripting languages which embed non-visual codes in a text document through the use of special ASCII text codes. Files in these formats may be easily transmitted across computer networks, including global information networks like the Internet, and allow the Browsers to display text, images, and play audio and video recordings. The Web utilizes these data file formats to conjunction with its communication protocol to transmit such information between servers and workstations. Browsers may also be programmed to display information provided in an eXtensible Markup Language (“XML”) file, with XML files being capable of use with several Document Type Definitions (“DTD”) and thus more general in nature than SGML or HTML. The XML file may be analogized to an object, as the data and the stylesheet formatting are separately contained (formatting may be thought of as methods of displaying information, thus an XML file has data and an associated method). Similarly, JavaScript Object Notation (JSON) may be used to convert between data file formats.

The terms “personal digital assistant”, or “PDA”, or smartphone as defined above, means any handheld, mobile device that combines two or more of computing, telephone, fax, e-mail and networking features. The terms “wireless wide area network” or “WWAN” mean a wireless network that serves as the medium for the transmission of data between a handheld device and a computer. The term “synchronization” means the exchanging of information between a first device, e.g. a handheld device, and a second device, e.g. a desktop computer or a computer network, either via wires or wirelessly. Synchronization ensures that the data on both devices are identical (at least at the time of synchronization).

Data may also be synchronized between computer systems and telephony systems. Such systems are known and include keypad based data entry over a telephone line, voice recognition over a telephone line, and voice over internet protocol (“VoIP”). In this way, computer systems may recognize callers by associating particular numbers with known identities. More sophisticated call center software systems integrate computer information processing and telephony exchanges. Such systems initially were based on fixed wired telephony connections, but such systems have migrated to wireless technology.

In wireless wide area networks, communication primarily occurs through the transmission of radio signals over analog, digital cellular or personal communications service (“PCS”) networks. Signals may also be transmitted through microwaves and other electromagnetic waves. Much wireless data communication takes place across cellular systems using second generation technology such as code-division multiple access (“CDMA”), time division multiple access (“TDMA”), the Global System for Mobile Communications (“GSM”), Third Generation (wideband or “3G”), Fourth Generation (broadband or “4G”), personal digital cellular (“PDC”), or through packet-data technology over analog systems such as cellular digital packet data (“CDPD”) used on the Advance Mobile Phone Service (“AMPS”).

The terms “wireless application protocol” or “WAP” mean a universal specification to facilitate the delivery and presentation of web-based data on handheld and mobile devices with small user interfaces. “Mobile Software” refers to the software operating system which allows for application programs to be implemented on a mobile device such as a mobile telephone or PDA. Examples of Mobile Software are Java and Java ME (Java and JavaME are trademarks of Sun Microsystems, Inc. of Santa Clara, California), BREW (BREW is a registered trademark of Qualcomm Incorporated of San Diego, California), Windows Mobile (Windows is a registered trademark of Microsoft Corporation of Redmond, Washington), Palm OS (Palm is a registered trademark of Palm, Inc. of Sunnyvale, California), Symbian OS (Symbian is a registered trademark of Symbian Software Limited Corporation of London, United Kingdom), ANDROID OS (ANDROID is a registered trademark of Google, Inc. of Mountain View, California), and iPhone OS (iPhone is a registered trademark of Apple, Inc. of Cupertino, California), and Windows Phone 7. “Mobile Apps” refers to software programs written for execution with Mobile Software.

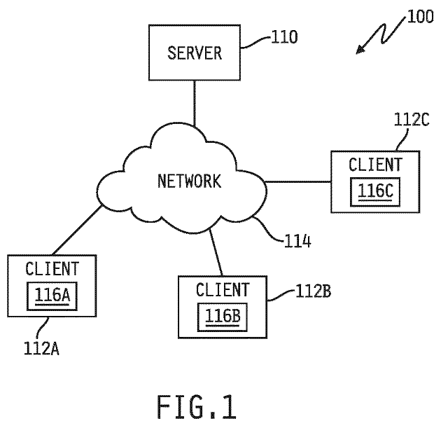

FIG. 1 is a high-level block diagram of a computing environment 100 according to one embodiment. FIG. 1 illustrates server 110 and three clients 112 connected by network 114. Only three clients 112 are shown in FIG. 1 in order to simplify and clarify the description. Embodiments of the computing environment 100 may have thousands or millions of clients 112 connected to network 114, for example the Internet. Users (not shown) may operate software 116 on one of clients 112 to both send and receive messages network 114 via server 110 and its associated communications equipment and software (not shown).

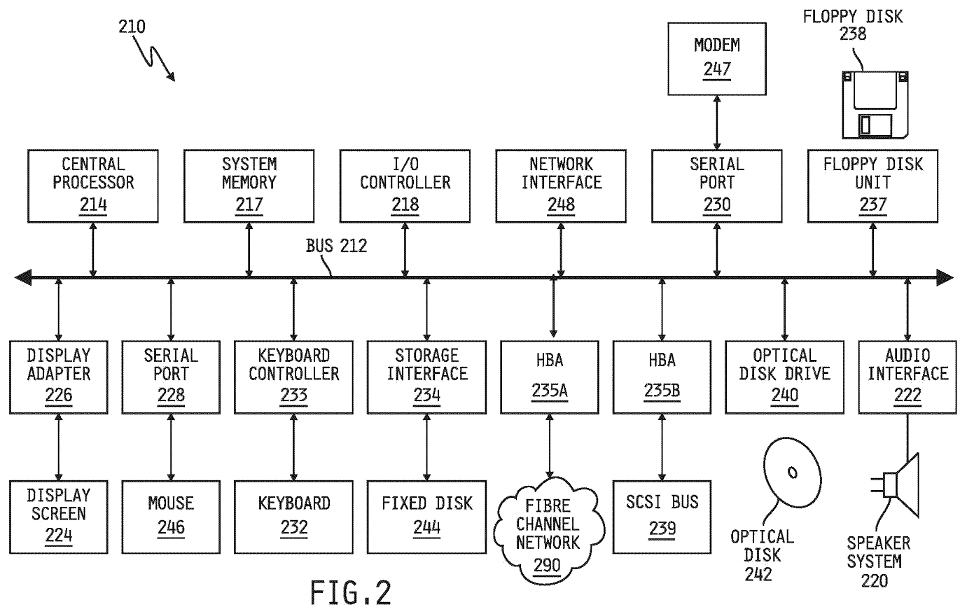

FIG. 2 depicts a block diagram of computer system 210 suitable for implementing server 110 or client 112. Computer system 210 includes bus 212 which interconnects major subsystems of computer system 210, such as central processor 214, system memory 217 (typically RAM, but which may also include ROM, flash RAM, or the like), input/output controller 218, external audio device, such as speaker system 220 via audio output interface 222, external device, such as display screen 224 via display adapter 226, serial ports 228 and 230, keyboard 232 (interfaced with keyboard controller 233), storage interface 234, disk drive 237 operative to receive floppy disk 238 (disk drive 237 is used to represent various type of removable memory such as flash drives, memory sticks and the like), host bus adapter (HBA) interface card 235A operative to connect with Fibre Channel network 290, host bus adapter (HBA) interface card 235B operative to connect to SCSI bus 239, and optical disk drive 240 operative to receive optical disk 242. Also included are mouse 246 (or other point-and-click device, coupled to bus 212 via serial port 228), modem 247 (coupled to bus 212 via serial port 230), and network interface 248 (coupled directly to bus 212).

Bus 212 allows data communication between central processor 214 and system memory 217, which may include read-only memory (ROM) or flash memory (neither shown), and random access memory (RAM) (not shown), as previously noted. RAM is generally the main memory into which operating system and application programs are loaded. ROM or flash memory may contain, among other software code, Basic Input-Output system (BIOS) which controls basic hardware operation such as interaction with peripheral components. Applications resident with computer system 210 are generally stored on and accessed via computer readable media, such as hard disk drives (e.g., fixed disk 244), optical drives (e.g., optical drive 240), floppy disk unit 237, or other storage medium. Additionally, applications may be in the form of electronic signals modulated in accordance with the application and data communication technology when accessed via network modem 247 or interface 248 or other telecommunications equipment (not shown).

Storage interface 234, as with other storage interfaces of computer system 210, may connect to standard computer readable media for storage and/or retrieval of information, such as fixed disk drive 244. Fixed disk drive 244 may be part of computer system 210 or may be separate and accessed through other interface systems. Modem 247 may provide direct connection to remote servers via telephone link or the Internet via an internet service provider (ISP) (not shown). Network interface 248 may provide direct connection to remote servers via direct network link to the Internet via a POP (point of presence). Network interface 248 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 2 need not be present to practice the present disclosure. Devices and subsystems may be interconnected in different ways from that shown in FIG. 2. Operation of a computer system such as that shown in FIG. 2 is readily known in the art and is not discussed in detail in this application. Software source and/or object codes to implement the present disclosure may be stored in computer-readable storage media such as one or more of system memory 217, fixed disk 244, optical disk 242, or floppy disk 238. The operating system provided on computer system 210 may be a variety or version of either MS-DOS® (MS-DOS is a registered trademark of Microsoft Corporation of Redmond, Washington), WINDOWS® (WINDOWS is a registered trademark of Microsoft Corporation of Redmond, Washington), OS/2® (OS/2 is a registered trademark of International Business Machines Corporation of Armonk, New York), UNIX® (UNIX is a registered trademark of X/Open Company Limited of Reading, United Kingdom), Linux® (Linux is a registered trademark of Linus Torvalds of Portland, Oregon), or other known or developed operating system. In some embodiments, computer system 210 may take the form of a tablet computer, typically in the form of a large display screen operated by touching the screen. In tablet computer alternative embodiments, the operating system may be iOS® (iOS is a registered trademark of Cisco Systems, Inc. of San Jose, California, used under license by Apple Corporation of Cupertino, California), Android® (Android is a trademark of Google Inc. of Mountain View, California), Blackberry® Tablet OS (Blackberry is a registered trademark of Research In Motion of Waterloo, Ontario, Canada), webOS (webOS is a trademark of Hewlett-Packard Development Company, L.P. of Texas), and/or other suitable tablet operating systems.

Moreover, regarding the signals described herein, those skilled in the art recognize that a signal may be directly transmitted from a first block to a second block, or a signal may be modified (e.g., amplified, attenuated, delayed, latched, buffered, inverted, filtered, or otherwise modified) between blocks. Although the signals of the above described embodiments are characterized as transmitted from one block to the next, other embodiments of the present disclosure may include modified signals in place of such directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

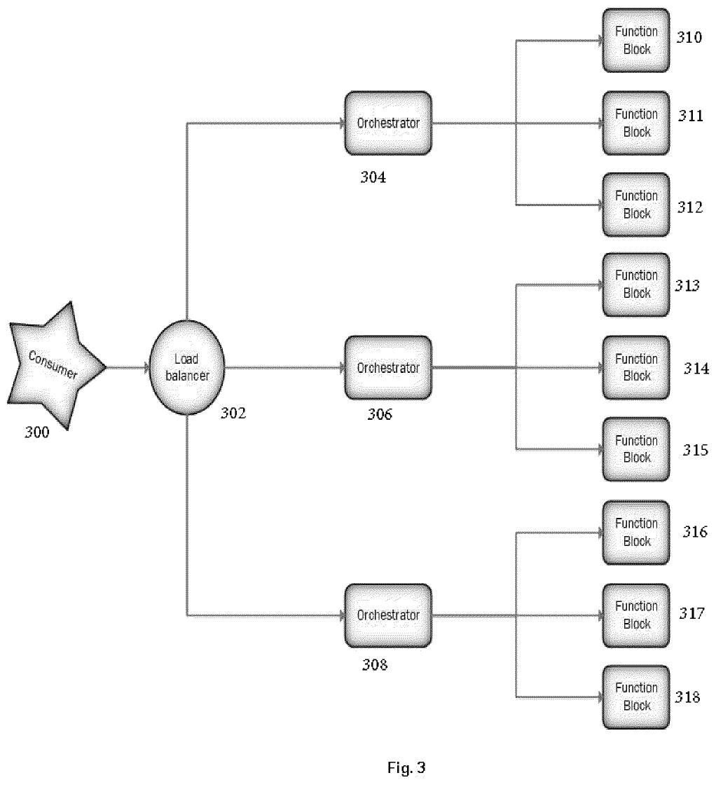

Embodiments of the invention provide a universal level of abstraction of the interaction environment, allowing communication with humans in every interaction environment and allows additions to any new interaction environment as a function of OPP. One representation of an embodiment of the invention is shown in FIG. 3. In that representation, consumer 300 may generate, through its computer interaction, for example without limitation, a browser request that may then be routed by any load balancer 302 module to Orchestrator 304, 306, 308. Each orchestrator represents a fully functional processing environment with a set of function blocks. Orchestrator is responsible for maintaining an infrastructure for its functional blocks (310, 311, 312; 313, 314, 315; 316, 317, 318). Each Orchestrator permanently analyses the health of his infrastructure and supports it in a permanently working state. Every instance of an Orchestrator has at least one working function block which is ready to process requests. Each orchestrator aggregates telemetry from his functional blocks and sends it to an external monitoring system in aggregated form.

In one embodiment, load balancer 302 comprises the computing machine, coding, associated memory and communications equipment required to perform the wide area network operating system functions, for example without limitation, an Arista AWE-7200E Series WAN Routing Platform from Arista Networks, Inc. of Santa Clara, California; a Cisco Catalyst 8500 Series Platform from Cisco Systems, Inc. of San Jose, California; or an MX Universal Routing Platform from Juniper Networks of Sunnyvale, California.

In embodiments, an orchestrator such as Orchestrator 304, 306, 308 may comprise computing machinery similar to that of load balancer 302, and elements of each of the orchestrator and/or load balancer may be distributed on combinations of those routing platforms.

In the various embodiments, each of the functional blocks (310, 311, 312; 313, 314, 315; 316, 317, 318) may comprise any type of computer with network connectivity, from a small single user device, such as a smartphone, tablet, personal computer, to a larger multiple function/user situation like a local area network (LAN), a main frame computer, etc. In its general operation, each functional block performs a specific task related to the instructions received from consumer 300. In one exemplary embodiment, consumer 300 may be shopping and the various functional blocks perform specific tasks like providing a product catalog with pictures and descriptions and pricing, coordinating a user interface enabling consumer 300 to purchase a product over network 110, such as the internet. In another exemplary embodiment, consumer 300 may be performing an accounting function for an employer, and the various functional blocks perform record-keeping functions in the employer's information systems.

OPP is used for internal processing, using multiple types of function blocks. For example: function block to access card operations through the host, to process any message requests, or know-your-customer (“KYC”) identity verification operations. Function block for accessing the card processing host contains functions to access various e-commerce modules: purchase, p2p debit, refund, reversal, p2p credit, tokenization, message passing interface (“MPI”). Function block for messaging may contain functions for sending email and SMS. Function block for KYC operations contains a set of functions to communicate with our KYC providers.

The process of collecting telemetry information looks like: Each function sends its own telemetry (word of state) to statistics controller 404 through message bus 410, statistics controller collects all words of state and calculates word of state for function block. After that, the statistics controller sends function block word of state to the subscribers (orchestrator is one of them). The orchestrator calculates the word of state for the tree and sends it to the subscribers (monitoring system is one of them).

In one embodiment, an exemplary telemetry information packet is in the form of data packet in a particular format, e.g., an XML specification providing various parameters of the functional block sending the data packet possibly including, without limitation, output data, state of function, required operations, etc.

The algorithm uses not only received words of state, but missing words of state are evaluated as a parameter for further distributed processing. The frequency of receiving the words of state, and length of every queue are all used as inputs to the determinations made by the system, for example without limitation, in a particular functional block, load balancer, or orchestrator.

In one embodiment, an exemplary RNA information packet may be in the form of data packet, e.g., an XML specification possibly including a parent process, any child processes, related processes, types of data and parameters used by the originating process, etc.

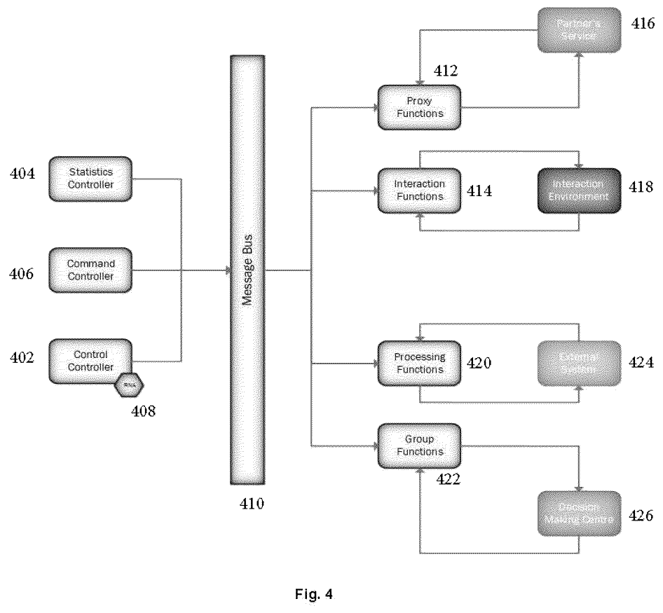

The general arrangement of a functional block is depicted in FIG. 4. The function block contains three controllers: Control 402, Statistics 404 and Command 406. Control Controller 402 is responsible for infrastructure. This controller reads RNA 408 from configuration and applies this RNA code to infrastructure. RNA contains information about other controllers and functions. RNA may be changed dynamically. Following are computer software code showing different ways to express and process such RNA information and metadata in an exemplary system for processing of electronic payments over a network.

```
RNA 0
{
  “FunctionBlock”: {
    “Components”: {
      “Controllers”: {
        “Command”: {
          “Identifier”: “db7964d8-0b4d-47bc-b559-baca2f1d53a7”,
          “Image”: “nexus.paysend.tech/opp/open-processing-
platform/core/functionblock.controller.command:v1.4.5”
        },
        “Statistics”: {
          “Identifier”: “a7aebdd2-2370-41d3-aeb9-84e6d0ed82fc”,
          “Image”: “nexus.paysend.tech/opp/open-processing-
platform/core/functionblock.controller.statistics:v1.2.4”
        }
      },
      “Functions”: [
        {
          “Name”: “baseinteractionfunction”,
          “Identifier”: “5190493a-8040-4f24-b1d6-94325f77e67d”,
          “Realm”: “Interaction”,
          “Image”: “nexus.paysend.tech/opp/open-processing-
platform/functions/base/interaction:base-1.2.3”
        },
        {
          “Name”: “httpnotification”,
          “Identifier”: “81a390dd-f51d-4b21-a8d8-3efa51a99cc7”,
          “Realm”: “Processing”,
          “Image”: “nexus.paysend.tech/opp/open-processing-
platform/functions/processing/notification/http-notification:v1.2.3”
        },
        {
          “Name”: “smartvista-purchase-1”,
          “Identifier”: “f55c74c5-516d-4cfc-a5de-a873c0e962b2”,
          “Realm”: “Processing”,
          “Image”: “nexus.paysend.tech/opp/open-processing-
platform/functions/processing/acquiring/sv-purchase:v1.0.6”
        },
        {
          “Name”: “smartvista-purchase-2”,
          “Identifier”: “99574584-f0d2-48f3-ab5a-ff8cb1d58bea”,
          “Realm”: “Processing”,
          “Image”: “nexus.paysend.tech/opp/open-processing-
platform/functions/processing/acquiring/sv-purchase:v1.0.6”
        },
        {
          “Name”: “smartvista-purchase-3”,
          “Identifier”: “26931ca2-7822-438a-8711-38ea661ff924”,
          “Realm”: “Processing”,
          “Image”: “nexus.paysend.tech/opp/open-processing-
platform/functions/processing/acquiring/sv-purchase:v1.0.6”
        },
        {
          “Name”: “smartvista-purchase-4”,
          “Identifier”: “56ee06bd-1954-44b9-88fc-5a448a8550d6”,
          “Realm”: “Processing”,
          “Image”: “nexus.paysend.tech/opp/open-processing-
platform/functions/processing/acquiring/sv-purchase:v1.0.6”
        },
        {
          “Name”: “smartvista-purchase-5”,
          “Identifier”: “99bf02b9-4c61-4fcd-9e56-7b405d9813d8”,
          “Realm”: “Processing”,
          “Image”: “nexus.paysend.tech/opp/open-processing-
platform/functions/processing/acquiring/sv-purchase:v1.0.6”
        },
        {
          “Name”: “smartvista-p2pdebit-1”,
          “Identifier”: “d6984573-8e08-4248-b0e0-352bda687b44”,
          “Realm”: “Processing”,
          “Image”: “nexus.paysend.tech/opp/open-processing-
platform/functions/processing/acquiring/sv-p2p-debit:v1.0.6”
        },
        {
          “Name”: “smartvista-p2pdebit-2”,
          “Identifier”: “ed67a335-6211-4714-9e88-93ba8268b26a”,
          “Realm”: “Processing”,
          “Image”: “nexus.paysend.tech/opp/open-processing-
platform/functions/processing/acquiring/sv-p2p-debit:v1.0.6”
        },
        {
          “Name”: “smartvista-p2pdebit-3”,
          “Identifier”: “1775f77b-ecac-4c8d-96b1-0d0248794083”,
          “Realm”: “Processing”,
          “Image”: “nexus.paysend.tech/opp/open-processing-
platform/functions/processing/acquiring/sv-p2p-debit:v1.0.6”
        },
        {
          “Name”: “smartvista-p2pdebit-4”,
          “Identifier”: “9a2cd7f0-1c6b-4ff5-ae6f-d9f32c60b64d”,
          “Realm”: “Processing”,
          “Image”: “nexus.paysend.tech/opp/open-processing-
platform/functions/processing/acquiring/sv-p2p-debit:v1.0.6”
        },
        {
          “Name”: “smartvista-p2pdebit-5”,
          “Identifier”: “eb03b6bc-c6ee-48f3-bbbe-c4e7b1e878b6”,
          “Realm”: “Processing”,
          “Image”: “nexus.paysend.tech/opp/open-processing-
platform/functions/processing/acquiring/sv-p2p-debit:v1.0.6”
        },
        {
          “Name”: “smartvista-p2pdebit-6”,
          “Identifier”: “117b92a3-8838-4213-add4-49efed6abd0c”,
          “Realm”: “Processing”,
          “Image”: “nexus.paysend.tech/opp/open-processing-
platform/functions/processing/acquiring/sv-p2p-debit:v1.0.6”
        },
        {
          “Name”: “smartvista-p2pdebit-7”,
          “Identifier”: “ccb29a08-7a33-481a-9b02-83b5c3ba67df”,
          “Realm”: “Processing”,
          “Image”: “nexus.paysend.tech/opp/open-processing-
platform/functions/processing/acquiring/sv-p2p-debit:v1.0.6”
        },
        {
          “Name”: “smartvista-p2pdebit-8”,
          “Identifier”: “c36cf853-3e5b-4c7a-addd-f6d1863df322”,
          “Realm”: “Processing”,
          “Image”: “nexus.paysend.tech/opp/open-processing-
platform/functions/processing/acquiring/sv-p2p-debit:v1.0.6”
        },
        {
          “Name”: “smartvista-p2pdebit-9”,
          “Identifier”: “a77f5858-7b95-4db7-89c6-73d57259ea73”,
          “Realm”: “Processing”,
          “Image”: “nexus.paysend.tech/opp/open-processing-
platform/functions/processing/acquiring/sv-p2p-debit:v1.0.6”
        },
        {
          “Name”: “smartvista-p2pdebit-10”,
          “Identifier”: “97884e18-4885-43be-936c-e1f2c7152ce2”,
          “Realm”: “Processing”,
          “Image”: “nexus.paysend.tech/opp/open-processing-
platform/functions/processing/acquiring/sv-p2p-debit:v1.0.6”
        },
        {
          “Name”: “smartvista-refund-1”,
          “Identifier”: “323d916c-2778-416a-bd05-580d8f54f6df”,
          “Realm”: “Processing”,
          “Image”: “nexus.paysend.tech/opp/open-processing-
platform/functions/processing/acquiring/sv-refund:v1.0.4”
        },
        {
          “Name”: “smartvista-refund-2”,
          “Identifier”: “9494f522-518c-4dae-9f94-51782f06e848”,
          “Realm”: “Processing”,
          “Image”: “nexus.paysend.tech/opp/open-processing-
platform/functions/processing/acquiring/sv-refund:v1.0.4”
        },
        {
          “Name”: “smartvista-refund-3”,
          “Identifier”: “5574b142-d743-48ca-beea-52a4e1872f2b”,
          “Realm”: “Processing”,
          “Image”: “nexus.paysend.tech/opp/open-processing-
platform/functions/processing/acquiring/sv-refund:v1.0.4”
        },
        {
          “Name”: “smartvista-refund-4”,
          “Identifier”: “f76bb60a-3ed7-47ae-8e5f-5000e6a68b95”,
          “Realm”: “Processing”,
          “Image”: “nexus.paysend.tech/opp/open-processing-
platform/functions/processing/acquiring/sv-refund:v1.0.4”
        },
        {
          “Name”: “smartvista-refund-5”,
          “Identifier”: “60018b77-cb1e-4756-9370-adacfb365eea”,
          “Realm”: “Processing”,
          “Image”: “nexus.paysend.tech/opp/open-processing-
platform/functions/processing/acquiring/sv-refund:v1.0.4”
        },
        {
          “Name”: “smartvista-reversal-1”,
          “Identifier”: “f9ecbf26-6596-4d3c-bd42-8c621061b1ee”,
          “Realm”: “Processing”,
          “Image”: “nexus.paysend.tech/opp/open-processing-
platform/functions/processing/acquiring/sv-reversal:v1.0.4”
        },
        {
          “Name”: “smartvista-reversal-2”,
          “Identifier”: “2a5eaa27-1a1b-4de1-84a5-84bdc178ba4d”,
          “Realm”: “Processing”,
          “Image”: “nexus.paysend.tech/opp/open-processing-
platform/functions/processing/acquiring/sv-reversal:v1.0.4”
        },
        {
          “Name”: “smartvista-reversal-3”,
          “Identifier”: “2bd3d7e3-e721-436f-8e63-61872381199e”,
          “Realm”: “Processing”,
          “Image”: “nexus.paysend.tech/opp/open-processing-
platform/functions/processing/acquiring/sv-reversal:v1.0.4”
        },
        {
          “Name”: “smartvista-reversal-4”,
          “Identifier”: “f88b9077-ba0e-4a44-8a3c-ed416cd5cf05”,
          “Realm”: “Processing”,
          “Image”: “nexus.paysend.tech/opp/open-processing-
platform/functions/processing/acquiring/sv-reversal:v1.0.4”
        },
        {
          “Name”: “smartvista-reversal-5”,
          “Identifier”: “9a237a17-4bdd-4954-8dcc-9edba435ae59”,
          “Realm”: “Processing”,
          “Image”: “nexus.paysend.tech/opp/open-processing-
platform/functions/processing/acquiring/sv-reversal:v1.0.4”
        },
        {
          “Name”: “smartvista-p2pcredit-1”,
          “Identifier”: “bc19bc9e-df7d-4186-8f63-638147f28a00”,
          “Realm”: “Processing”,
          “Image”: “nexus.paysend.tech/opp/open-processing-
platform/functions/processing/acquiring/sv-p2p-credit:v1.1.3”
        },
        {
          “Name”: “smartvista-p2pcredit-2”,
          “Identifier”: “012526a5-8461-4757-8f5b-ccdc89b270f8”,
          “Realm”: “Processing”,
          “Image”: “nexus.paysend.tech/opp/open-processing-
platform/functions/processing/acquiring/sv-p2p-credit:v1.1.3”
        },
        {
          “Name”: “smartvista-p2pcredit-3”,
          “Identifier”: “e5c0abc0-8f72-4168-a4cb-4f229fe33266”,
          “Realm”: “Processing”,
          “Image”: “nexus.paysend.tech/opp/open-processing-
platform/functions/processing/acquiring/sv-p2p-credit:v1.1.3”
        },
        {
          “Name”: “smartvista-p2pcredit-4”,
          “Identifier”: “9bbd3e92-2bf9-400d-84b8-84800d108338”,
          “Realm”: “Processing”,
          “Image”: “nexus.paysend.tech/opp/open-processing-
platform/functions/processing/acquiring/sv-p2p-credit:v1.1.3”
        },
        {
          “Name”: “smartvista-p2pcredit-5”,
          “Identifier”: “b69b9724-39d3-47cb-a112-8ea16c7c1cfe”,
          “Realm”: “Processing”,
          “Image”: “nexus.paysend.tech/opp/open-processing-
platform/functions/processing/acquiring/sv-p2p-credit:v1.1.3”
        },
        {
          “Name”: “tokenization”,
          “Identifier”: “9e7d78d6-2fed-43bd-aa3d-36b58a815e77”,
          “Realm”: “Processing”,
          “Image”: “nexus.paysend.tech/opp/open-processing-
platform/ functions/processing/acquiring/tokenization:v1.3.1”
        },
        {
          “Name”: “mpi”,
          “Identifier”: “21ff37c8-e5df-4fb2-b204-43451b2e21d9”,
          “Realm”: “Processing”,
          “Image”: “nexus.paysend.tech/opp/open-processing-
platform/functions/processing/acquiring/mpi:v1.0.3”
        },
        {
          “Name”: “callback-waiter”,
          “Identifier”: “45040253-2c38-4d3e-960e-ee34c328a6b5”,
          “Realm”: “Processing”,
          “Image”: “nexus.paysend.tech/opp/open-processing-
platform/functions/processing/acquiring/callback-waiter:v1.0.2”
        }
      ]
    }
  }
}
RNA 1
{
  “FunctionBlock”: {
    “Components”: {
      “Controllers”: {
        “Command”: {
          “Identifier”: “db7964d8-0b4d-47bc-b559-baca2f1d53a7”,
          “Image”: “nexus.paysend.tech/opp/open-processing-
platform/core/functionblock.controller.command:v1.3.5”
        },
        “Statistics”: {
          “Identifier”: “a7aebdd2-2370-41d3-aeb9-84e6d0ed82fc”,
          “Image”: “nexus.paysend.tech/opp/open-processing-
platform/core/functionblock.controller.statistics:v1.2.2”
        }
      },
      “Functions”: [
        {
          “Name”: “baseinteractionfunction”,
          “Identifier”: “5190493a-8040-4f24-b1d6-94325f77e67d”,
          “Realm”: “Interaction”,
          “Image”: “nexus.paysend.tech/opp/open-processing-
platform/functions/base/interaction:base-
1.2.2@sha256:b5adca8ac79a36797454885182ddae69bd680bac99b765045356389
0ce3868c3”
        },
        {
          “Name”: “httpnotification”,
          “Identifier”: “81a390dd-f51d-4b21-a8d8-3efa51a99cc7”,
          “Realm”: “Processing”,
          “Image”: “nexus.paysend.tech/opp/open-processing-
platform/functions/processing/notification/http-
notification:v1.2.2@sha256:8b5377a89afc843826e992135616bcf88047ac8d2
16a43fa0bf863affca70d4d”
        },
        {
          “Name”: “sendgrid”,
          “Identifier”: “4a4f8b4f-3d4c-4a0c-aaf8-8d61d1a95201”,
          “Realm”: “Processing”,
          “Image”:
“nexus.paysend.tech/jvmlab/opp/functions/processing/sendgrid:1.4.0”
        },
        {
          “Name”: “twilio”,
          “Identifier”: “541fe75e-43db-11ee-be56-0242ac120002”,
          “Realm”: “Processing”,
          “Image”:
“nexus.paysend.tech/jvmlab/opp/functions/processing/twilio:0.0.0-
4.d5708ada-SNAPSHOT”
        },
        {
          “Name”: “mitto”,
          “Identifier”: “283162fa-50a9-11ee-be56-0242ac120002”,
          “Realm”: “Processing”,
          “Image”:
“nexus.paysend.tech/jvmlab/opp/functions/processing/mitto:0.0.0-
6.1d279f27-SNAPSHOT”
        }
      ]
    }
  }
}
RNA 2
{
  “FunctionBlock”: {
    “Components”: {
      “Controllers”: {
        “Command”: {
          “Identifier”: “db7964d8-0b4d-47bc-b559-baca2f1d53a7”,
          “Image”: “nexus.paysend.tech/opp/open-processing-
platform/core/functionblock.controller.command:v1.3.5”
        },
        “Statistics”: {
          “Identifier”: “a7aebdd2-2370-41d3-aeb9-84e6d0ed82fc”,
          “Image”: “nexus.paysend.tech/opp/open-processing-
platform/core/functionblock.controller.statistics:v1.2.2”
        }
      },
      “Functions”: [
        {
          “Name”: “baseinteractionfunction”,
          “Identifier”: “5190493a-8040-4f24-b1d6-94325f77e67d”,
          “Realm”: “Interaction”,
          “Image”: “nexus.paysend.tech/opp/open-processing-
platform/functions/base/interaction:base-
1.2.2@sha256:b5adca8ac79a36797454885182ddae69bd680bac99b765045356389
0ce3868c3”
        },
        {
          “Name”: “httpnotification”,
          “Identifier”: “81a390dd-f51d-4b21-a8d8-3efa51a99cc7”,
          “Realm”: “Processing”,
          “Image”: “nexus.paysend.tech/opp/open-processing-
platform/functions/processing/notification/http-
notification:v1.2.2@sha256:8b5377a89afc843826e992135616bcf88047ac8d2
16a43fa0bf863affca70d4d”
        },
        {
          “Name”: “ofakim-kyc”,
          “Identifier”: “541fe498-43db-11ee-be56-0242ac120002”,
          “Realm”: “Processing”,
          “Image”:
“nexus.paysend.tech/jvmlab/opp/functions/processing/ofakim-
kyc:0.0.0-7.4a2af43f-SNAPSHOT”
        }
      ]
    }
  }
}
```

Control controller 402 also permanently analyzes the health of the whole block. One of the main functions, after working with RNA, is to support function block in ready to process state. Each block is designed to have the full set of functions to process any request at any time. In one embodiment, the control sequence of control controller 402 is on a first-come, first-serve basis. In other embodiments, control controller 402 may utilize a load balancing algorithm such as round robin load balancing, least response, least connection, which optionally may be periodically improved by machine learning from information derived from telemetry and/or RNA data.

Statistics controller 404 is responsible for collecting and analyzing telemetry from each component. Collected and aggregated telemetry may be sent to subscribers, for example without limitation, by sending to one of the Orchestrators of FIG. 3. In one embodiment, statistics controller 404 provides telemetry data in the form of packets, e.g., an XML specification possibly including nodal, time, and amount of processing statistics from various functional blocks.

Command controller 406 is responsible for receiving processing requests and sending responses. In its general operation, command controller 406 performs the steps of allocating computing functions to available functional blocks capable of performing required actions in a processing environment, much like a time slice scheduler in a multiplexed single CPU, with the further allocation of functional blocks and other computing resources in the system.

Controllers 402, 404, 406, and 408 operated through message bus 410 to coordinate with proxy functions 412, interaction functions 414, processing functions 420, and group functions 422 to allow processes to access external computing resources. Proxy functions 412, in one embodiment, may provide a gateway to partner service 416 such as an image server. Interaction functions 414, in one embodiment, may provide a gateway to interaction environment 418 such as a graphics module. Processing functions 420, in one embodiment, may provide a gateway to external system 424 such as a currency exchange quoting service. Group functions 422, in one embodiment, may provide a gateway to decision making centre 426 such as an identity confirmation service.

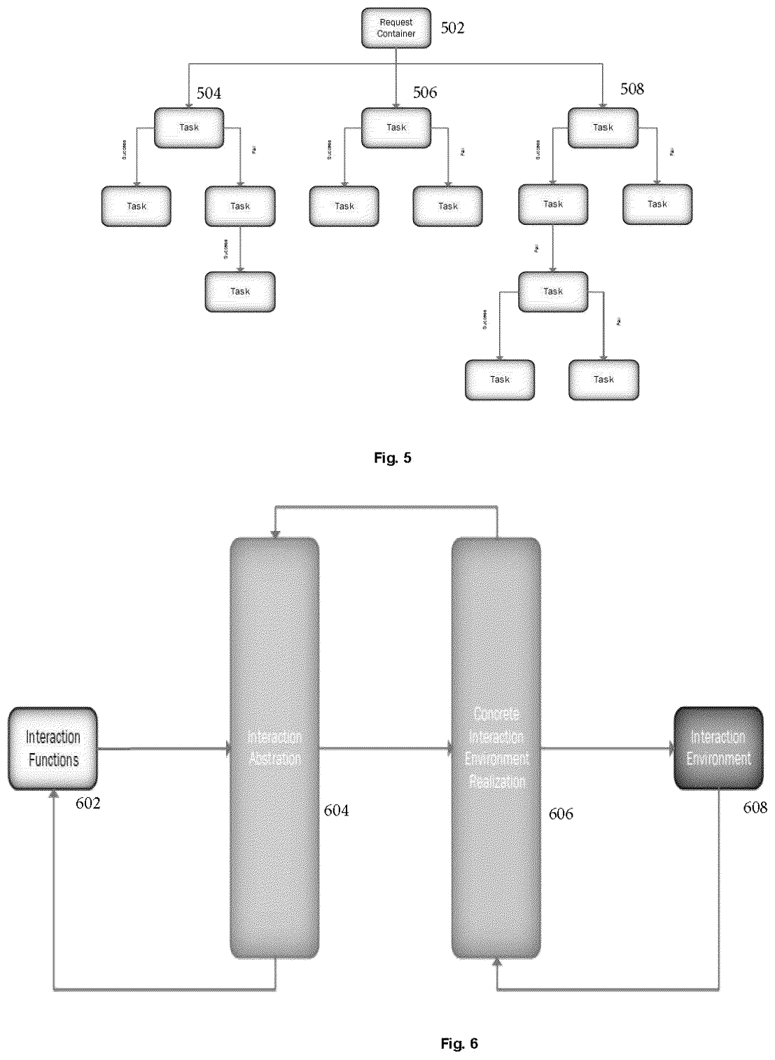

Embodiments of the invention also allow for delegated logic, as depicted in FIG. 5. Using the above-described schema, embodiments of the invention allow for the possibility to send a set of request trees in a single request to request container 502. In each request, the sender may configure logic trees, alternatively a request may be processed and distributed into a plurality of logic trees. As shown in FIG. 5, each tree 504, 506, 508 executes in parallel mode.

OPP supports templates on the task and requests layer to help simplify requests. Payloads of each task may be used as storage to save data that may be needed on the requestor's side after processing. Tree routing supports a simple routing mechanism. After execution of the task, the system can choose one of three ways in reference to the execution result: success, fail and always.

Embodiments of the invention further provide adaptability to future interaction functions 602 as illustrated in FIG. 6. OPP contains interaction abstraction layer 604; this layer 604 offers a universal interface 608 to communicate with humans. Abstraction layer 604 communicates with concrete realization layer 606 of the interaction environment 608. Humans communicate with OPP in concrete interaction environment 606. Each function asks to interact with a human if the function is not found needed data in the payload. Communication with humans happens through a special alphabet for interaction. As a part of abstraction layer 604. This approach allows communication by a single communication flow without dependency on a particular concrete interaction environment 606. Adding a new interaction environment 602 only requires adding new concrete realization 606 without changes outside such a new module.

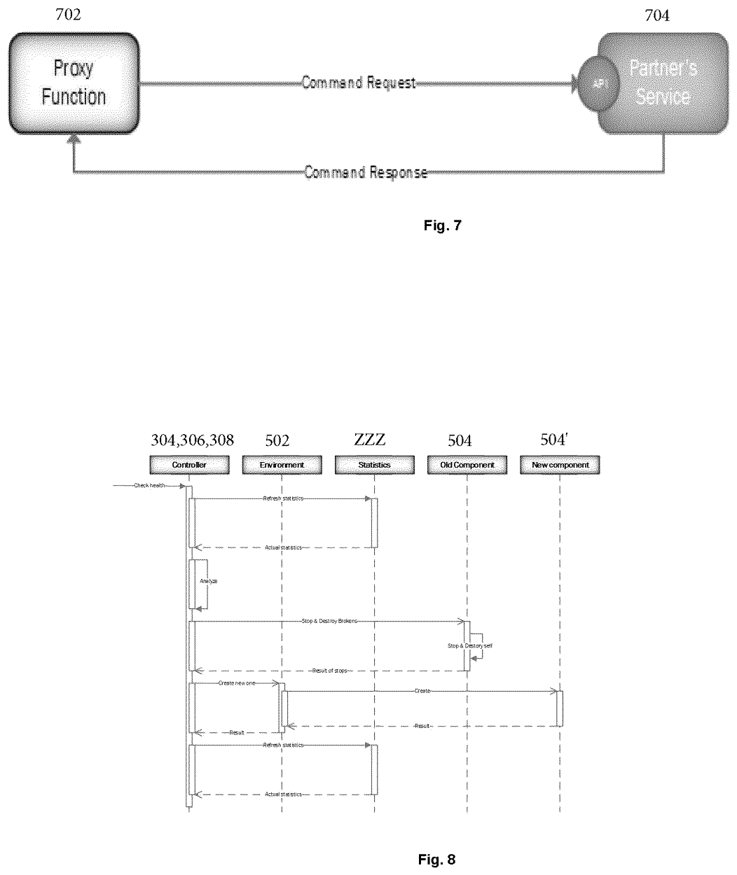

Similarly, FIG. 7 shows how embodiments of the invention manage independent tasks. Each task is represented by proxy function 702. OPP provides a transactional stream to any external partner through standardized API where external source 704 merely implements the OPP internal communication mechanism. That approach allows OPP to use these external systems 704 as an internal function through proxy function 702. Proxy function 702 is responsible only for mapping OPP's advanced message queuing protocol (AMQP) messages into hyper-text transfer protocol (HTTP) messages. Security for these messages may be provided by the infrastructure layer.

Autonomy is provided in several embodiments of the invention by the schema shown in FIG. 8. OPP and its systems are designed to work in a Cloud. Based on the fact that infrastructure elements may be created faster than local computing and cheaper than local computing. OPP does not spend resources to repair broken elements. Rather, the OPP behavior is analogous to biology T-lymphocyte, if OPP detects a broken component, OPP sends s kill signal to it and immediately creates a replacement. This approach is used in all systems, with periodic checks on telemetry statistics for any element of the entire OPP systems. There is no difference between function block or function, the controllers monitor processes through multiple channels and when circumstances indicate, end the processing of an old component found to be flawed, for example task tree 504 and start the processing of a new, replacement component, for example task tree 504′. The following paragraphs provide exemplary embodiments of the create-monitor-destroy-recreate dynamic in multiple embodiments of the present invention.

In one exemplary embodiment, the beginning orchestrator tree creates from the creating orchestrator, orchestrator starts analyzing available environment for processing. Because this contemplates starting from scratch, no function blocks are available, and the orchestrator creates the first function block through creating the control controller for it. The control controller in function block looks around and tries to find controllers and functions from RNA. Because nothing exists around, the control controller starts to create controllers and functions from RNA.

In another exemplary embodiment, if traffic of requests comes, some functions may start to have more than the configured number of operations in queue. The control controller, through the statistics controller, starts to understand this situation, and creates a new one instance of the affected function to reduce traffic pressure on it.

Still another exemplary embodiment involves a situation where some function in a function block is broken, such that the word of state for this function block loses operable flag. The orchestrator starts to understand that a function block is not ready to process requests. All traffic starts to exclude the broken function block, and the orchestrator creates a new one for the system. Broken function block goes to error state. The orchestrator waits a configurable amount of time to get a chance to repair for the broken function block. If function block not repaired by itself, the orchestrator removes this infrastructure component.

While one or more embodiments of this invention have been described as having an illustrative design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A server connected to a network for adaptively managing process implementation on a plurality of computing devices connected to the network, the server comprising:
a collecting module adapted to collect telemetry data relating to a plurality of instances of network processes managed by the server;
a identifying module adapted to identify telemetry data comprising an instance network process failure;
a RNA determining module adapted to determine the RNA of the instance network process failure; and
a creating module adapted to create at least one new instance of a network process based on the determined RNA.

2. A method of using a computer to adaptively manage process implementation through a network appliance connected between computing devices connected through a network, said method comprising the steps of:
collecting, by the network appliance, telemetry data relating to a plurality of instances of network processes managed by the network appliance;
determining through the network appliance, telemetry data comprising an instance network process failure;
determining the RNA of the instance network process failure; and
creating, by the network appliance, at least one new instance of a network process based on the determined RNA.

3. A machine-readable program storage device for storing encoded instructions for a method of adaptively managing process implementation through a network appliance connected between computing devices connected through a network, said method comprising the steps of:
collecting, by the network appliance, telemetry data relating to a plurality of instances of network processes managed by the network appliance;
determining through the network appliance, telemetry data comprising an instance network process failure;
determining the RNA of the instance network process failure; and
creating, by the network appliance, at least one new instance of a network process based on the determined RNA.
